(19) United States
(12) Patent Application Publication
(10) Pub. No.: US 2006/0190805 A1
(43) Pub. Date: Aug. 24, 2006

(54) Graphic-aided and audio-commanded document management and display systems

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 11/340,311

(22) Filed: Jan. 26, 2006

Related U.S. Application Data
(63) Continuation-in-part of application No. 09/483,317, filed on Jan. 14, 2000.
(60) Provisional application No. 60/647,576, filed on Jan. 26, 2005.
(60) Provisional application No. 60/115,919, filed on Jan. 14, 1999.

(51) Int. Cl. G06F 17/21; G06F 7/00

(52) U.S. Cl. 715/500; 707/7

(57) ABSTRACT

A document management system is disclosed in this invention. The document management system includes a document reading means for reading a document having textual descriptions and at least a drawing consisted of graphic elements each with an associated alpha-numeral designation. The document reading means is further provided for converting the document to a plurality of processor-recognized elements. The document management system further includes a search and link means for searching the processor-recognized elements and linking each of the graphic elements with at least one associated segment of textual description. The document management system further includes a display means for displaying the drawing with each of the graphic elements displayed together with the associated segment of textual description. In a preferred embodiment, the search and link means for searching and linking the associated segment of textual description for each of the graphic element further includes a document-location-finder means for locating a column number, a page number, and a line-range number for the associated segment of textual description. The display means is further provided for displaying the column number, the page number, and the line-range number for the segment of textual description for each of the graphic elements.

This application is a Formal Application of a previously Filed Provisional Application 60/647,576 and a Continuous in Part (CIP) Application of a previously filed co-pending patent application Ser. No. 09/483,317 filed on Jan. 14, 2000. Patent application Ser. No. 09/483,317 is a Formal Application benefited from a Provisional Patent Application 60/115,919 filed on Jan. 14, 1999.

### BACKGROUND OF THE INVENTION

1. Field of the Invention

This invention relates generally to a document review and presentation management system. More particularly, this invention relates to a graphic-based and video-linked document review and presentation management system wherein textual descriptions of each graphic element are arranged for display together with the graphic element and linkable to a video display and further to a voice recognition system to provide enhanced document review, examination, display and presentation.

2. Description of the Prior Art

The arrangement of a document with graphic illustrations showed on pages different from the relevant text descriptions often causes inconvenience in reading and understanding the contents of the document. Flipping back and forth between pages in attempt to correlate the textual descriptions to various graphic elements located on different pages often requires extra times and efforts. Particular example is a patent document where the drawings, e.g., FIG. 1A, are included in first part of the patent, typically starting from second page, as drawings of various preferred embodiments. While the description of these preferred embodiments are included in the last part of the patent document as that shown in FIG. 1B. Review of a patent document requires a document reviewer to simultaneously read the texts and view the drawings in parallel. Often, it is inconvenient not only because the document is required to flip back and forth between different parts of the document, but also relevant textual sections are also dispersed at different parts of the document. Especially, in a patent document, a claim element may be described in the Detail Description of Preferred Embodiment, and then presented in several claims. The Examiner must review the drawings and the textual descriptions to determine if the claims have sufficient support. Such review must be carried out in greater details, particularly if the questions are related to how the elements are claimed. Even though the drawings are included in a patent document, it is often inconvenient and cumbersome to make best use of the drawings due to the arrangement of separating the drawings into particular section from the textual descriptions and the claims. Referring also to FIGS. 1C and 1D for drawings included in a technical paper and a technical manual. Again, a document reviewer has to search among many sections of document to find relevant descriptions of particular graphical elements to gain understanding of the descriptions.

Advancements in computer search and document management do not yet benefit or help the tasks that are performed by a Patent Examiner of patent document reviewer. The “search engines” and “document linkers” or “desktop publishing” systems can link and associate textual or graphic terms between different documents, or can insert graphic drawings into different parts of the documents. However, none of these systems is provided to arrange and present the relevant information and data related to a particular graphical element for the convenience of review and understanding by relating or linking the textual descriptions or claimed terms to a corresponding graphic element.

Rivette et al. disclosed in U.S. Pat. Nos. 5,991,751 and 5,991,780 a system, method and computer program product for displaying a patent document and a patent image. The system and method are useful in reducing the stress in review a document by displaying the text in a side-by-side display page. However, a document reviewer is still required to look “left-and-right” to compare the textual descriptions with the displayed image for understanding the content of the documents. Simultaneous and side-by-side displays are not sufficient to completely resolve the difficulties faced by a document reviewer. Specifically, the spatial distance between the displayed graphic elements and the textual descriptions including the name of each displayed element prevents a direct and immediate association.

In U.S. Pat. No. 5,625,827 entitled “Method and System of Blueprint Document Manipulation”, Krause et al. disclose a system that allows the storing of construction drawings or blueprints in a plurality of computer files. The system allows automatic determinations of lengths, areas and count of dimensions displayed in drawings. The measured dimensions are provided in terms of real world or full-scale quantities. A scale between the full-scale quantities and computer-displayed dimensions is determined for each file to allow subsequent measurements scaled in terms of the original blueprint designated dimensions. The dimensions are identified with particular product items so that a quantity of items and costs thereof may be automatically determined and reported. However, in this patented invention, manipulations of display elements between multiple files are required and graphical elements representing data and information related in hierarchical relationship are presented. For application such as patent claim examination and litigations, graphic display for data and information with linear relationship are more frequently employed. Therefore, Krause does not provide a solution for the difficulties as now encountered in the conventional systems for documentation examination and management.

Therefore, there is still a need in the art of document management and information presentation to provide a document configuration with particular arranged presentation for conveniently reviewing and examining a document. The document configuration is arranged such that the review and examination of the document is aided by the graphic elements included in the document. Presentation of drawings together with the textual descriptions immediately near the graphic elements and also the claim languages may then be displayed when commanded by a document reviewer. The inconvenience and difficulties in reviewing and examining a document may then be resolved.

### SUMMARY OF THE PRESENT INVENTION

In one aspect of the present invention, a document management and review system is provided for linking and presenting each of the graphical elements with associated textual descriptions and related claimed elements in the claims in a patent application such that the aforementioned difficulties and inconveniences can be resolved.

Specifically, another aspect of the present invention is to provide a novel document management and presentation system to search and link textual descriptions to claim elements in different claims of a patent document. Furthermore, the claim elements are also linked to the alpha-numeral designations as illustrated as the graphic elements in the patent drawings. A link is first established between a claim-term to an alpha-numeral designation for each of the graphical elements associated with a naming-term as part of the textual description wherein the naming term may or may not be exactly identical to the claim term. Then all related descriptions for that particular naming-term are linked and gathered in a list file for that graphic element. The list file can then be displayed along with the associated graphic element for convenience of document review and presentation.

Another aspect of the present invention is to provide a novel graphic-based document review system by providing user options to review the drawings in a patent application either with the associated textual descriptions or with the claim languages of a patent document. The textual descriptions or the claim languages are displayed in a text box next to a related graphic element. Or, a document reviewer may enter a naming-term to invoke a graphic presentation related to that naming-term and all the associated descriptions and/or claim languages for that naming-term in a text box next to the graphic element associated with that naming-term.

Another aspect of the present invention is to provide a novel graphic-based document review and management system by providing a claim chart to present in a table the claim element in a first column and the textual description for that claim element in a second column followed a graphic element in a third column such that documentation for a patent litigation can be more conveniently managed and processed. For convenience of argument in a jury presentation, a fourth column is included to link to a video presentation for showing the function and features of a claim element further a fifth column may be added to present a video or graphic presentation related to a product, manufacturing processes or relevant circumstances for a contentious subject in a law suit.

Briefly, in a preferred embodiment, the present invention includes a document management system. The document management system includes a document reading means for reading a document having textual descriptions and at least a drawing consisted of graphic elements each designated with an associated alpha-numeral designation. The document reading means is further provided for converting the document to a plurality of processor-recognized elements. The document management system further includes a search and link means for searching the processor-recognized elements and linking each of the graphic elements with at least one associated segment of textual description. The document management system further includes a display means for displaying the drawing with each of the graphic elements displayed together with the associated segment of textual description. In a preferred embodiment, the search and link means for searching and linking the associated segment of textual description for each of the graphic element further includes a document-location-finder means for locating a column number, a page number, and a line-range number for the associated segment of textual description. The display means is further provided for displaying the column number, the page number, and the line-range number for the segment of textual description for each of the graphic elements.

In another preferred embodiment, this invention discloses a document process and management system to process a patent document for automatically generating a claim chart by presenting in a multiple column table including a first column listing a claim element of the patent and a second column listing a description of the claim element in the description of the patent. In another preferred embodiment, the description of the claim element in the second column further marked with a column number and line number as a location pointer of the description in the patent document. In another preferred embodiment, the multiple-column table further includes an additional column for presenting a graphic or video image related to the claim element. The graphic or video image may be a graphic element may be a graphic element of a drawing of the patent document. The graphic or video image may be a video for showing a structure, function, feature, manufacturing process or related information or data for the claim element. The graphic or video image may be an image or video for showing information related to an alleged infringing product.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIGS. 1A is a typical patent drawing included in the first part of the patent document;

FIG. 1B shows a relevant descriptions for the drawing of FIG. 1A printed on a last part of the patent document;

FIGS. 1C to 1D are drawings included in a technical paper and a technical manual generally separated from the sections of descriptions related to the graphical elements;

FIG. 2 is a functional block diagram of a document management system according to the present invention;

FIG. 3 is a flowchart for illustrating the processing steps for carrying out a document management process of this invention; and

FIGS. 4A to 4C show a graphic presentation with better correlation between the textual descriptions and the relevant graphic element as processed by the document management system of this invention.

FIG. 5A shows a functional block diagram of a document processing system of this invention.

FIG. 5B shows a multiple-column table generated by a document processing system of FIG. 5A.

### DETAILED DESCRIPTION OF THE PREFERRED EMBODIMENT

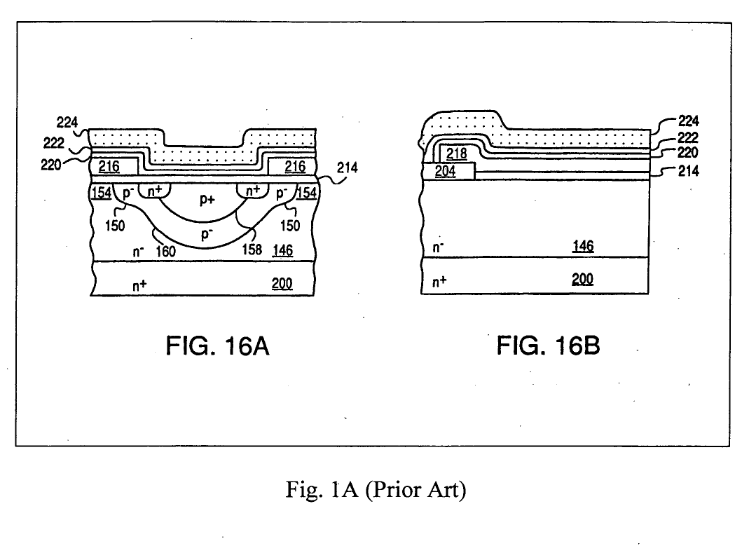

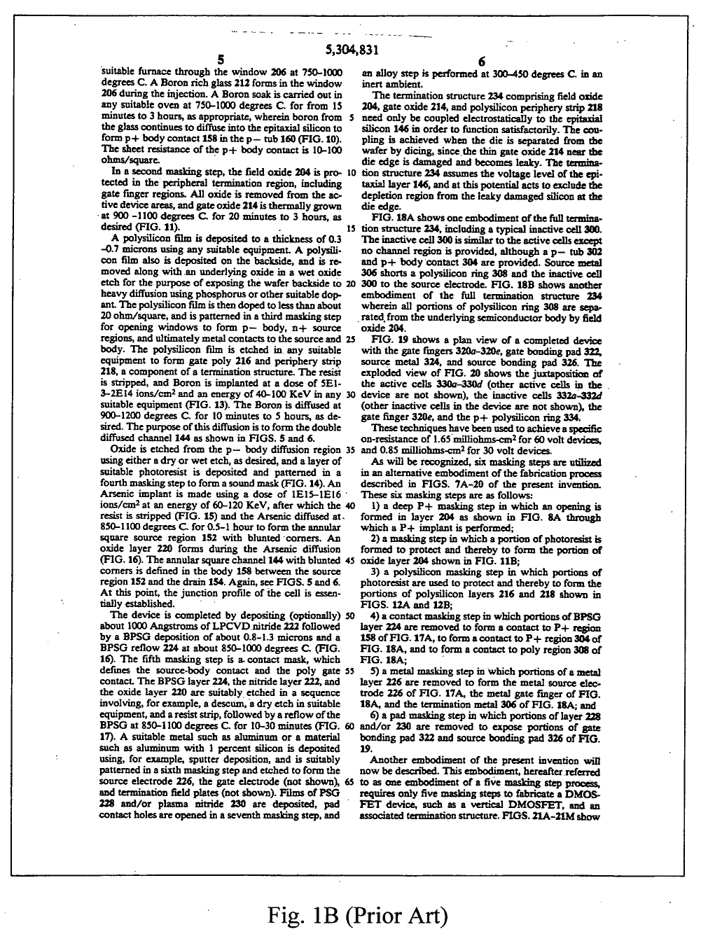

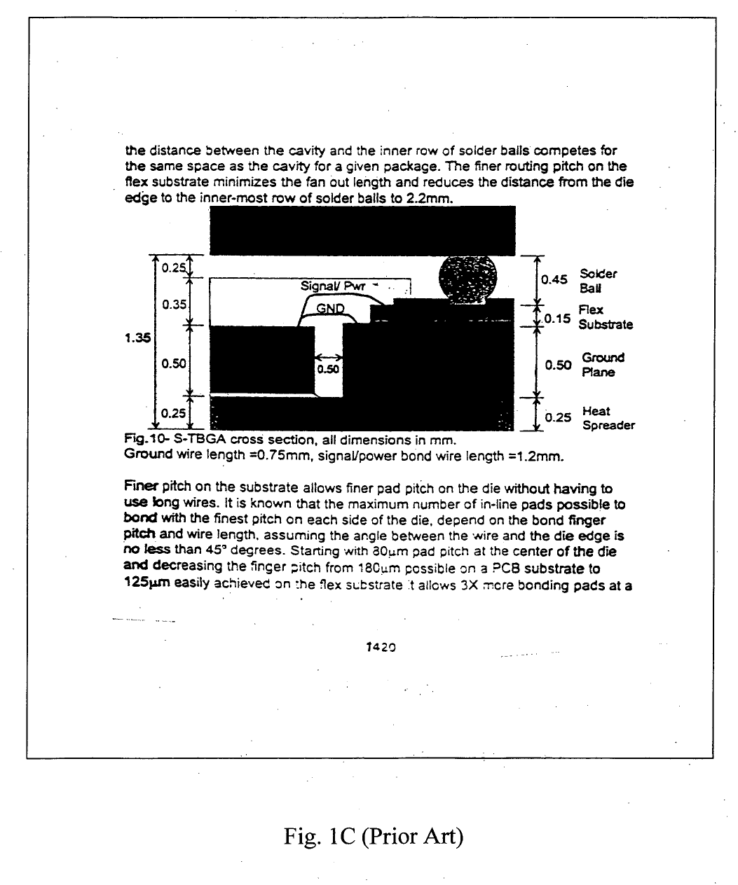

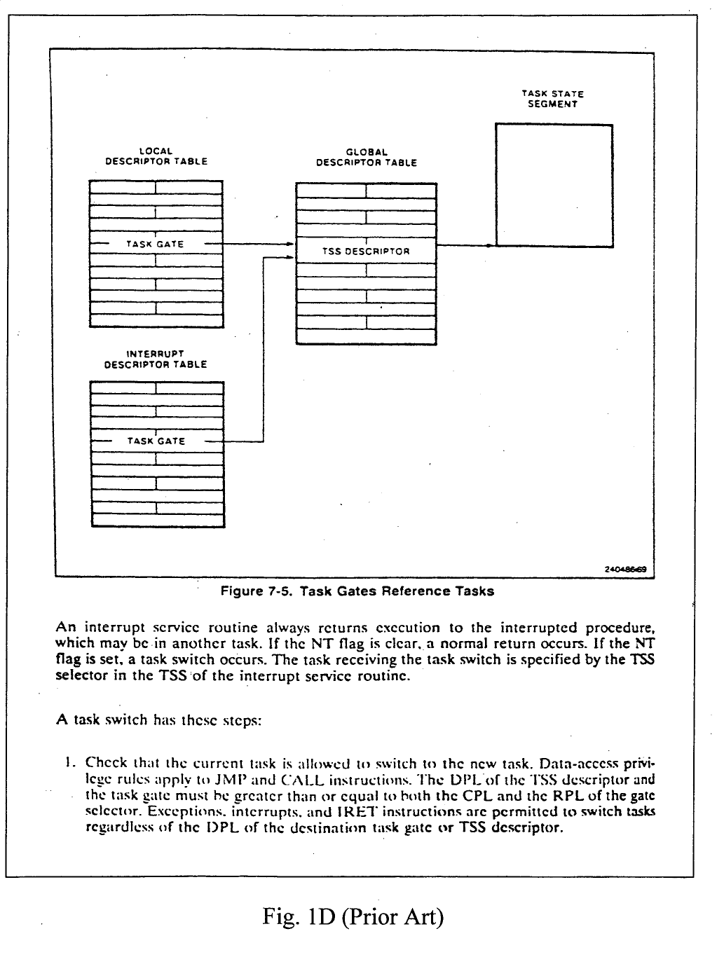

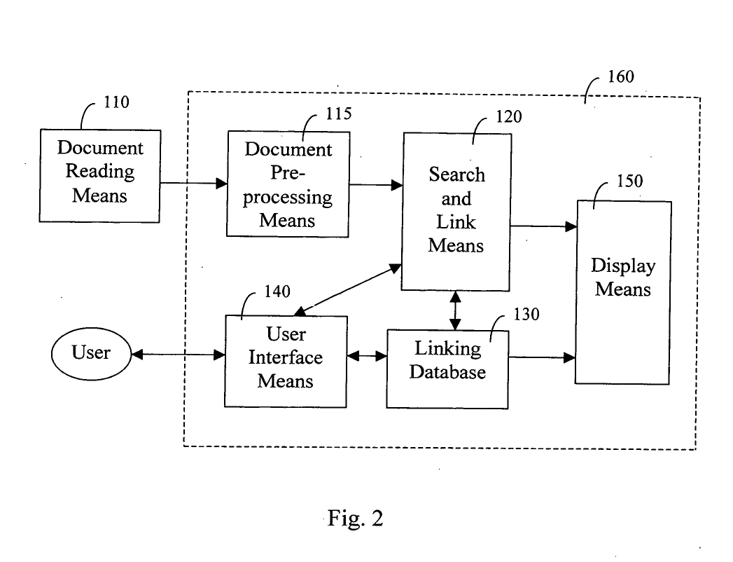

FIG. 2 is a functional block diagram for illustrating a document management system 100 of this invention. The document review management system includes a document reading means 110 for receiving a document either in processor-recognizable form, i.e., commonly called soft-copy or electronic-copy, or a hard-copy, e.g., a paper copy. The document management system 100 further includes a document preprocessing means 115 for converting the input document on a hard copy to a processor recognizable form. The input document after it is converted to its processor-recognizable form also includes the graphic elements. Each of these graphic elements is associated with a processor-recognizable alpha-numeral designation. The alpha numeral designation for each graphic element is either a numeral designation most commonly used in the drawings of a patent document such as that shown in FIG. 1A or a textual name often used in a technical paper as that shown in FIG. 1C, or user manuals as that shown in FIG. 1D.

The document management system 100 further includes a search and link means 120. The search and link means 120 applies each of the alpha-numeral designations for each of the graphic elements to perform a search and link operation. A search is first performed to search for a naming-term for an alpha numeral designation. For a patent document, the designation of a graphic element is usually a numeral designation. A naming-term associated with that numeral designation is first searched and identified. The document management system further includes a linking database 130. The linking database provides associations between each of these alpha-numeral designations to a naming term. The linking database further provides associations between each of the alpha-numeral designations to a graphic element and at least an associate portion of textual description of the naming terms. Specifically, for each of these identified naming-terms or an alpha-numeral designation, the entire document is searched to establish an associated text-file and all of these text files are stored in the linking database. The document system further includes a user interface means 140, which could be graphic user interface (GUI) to receive user command to perform different document management functions. The document management system 100 further includes a display means 150 that could be a monitor of a personal computer for showing the graphic display of the document and the associate text descriptions. In a typical preferred embodiment, the document pre-processing means 115, the search and link means 120, the lining database 130, the user interface means 140 and the display means 150 are incorporated in a personal computer (PC). And, the document reading means 110 is a document scanner 110 for scanning a document and generates an output to the PC for further textual and graphic processing.

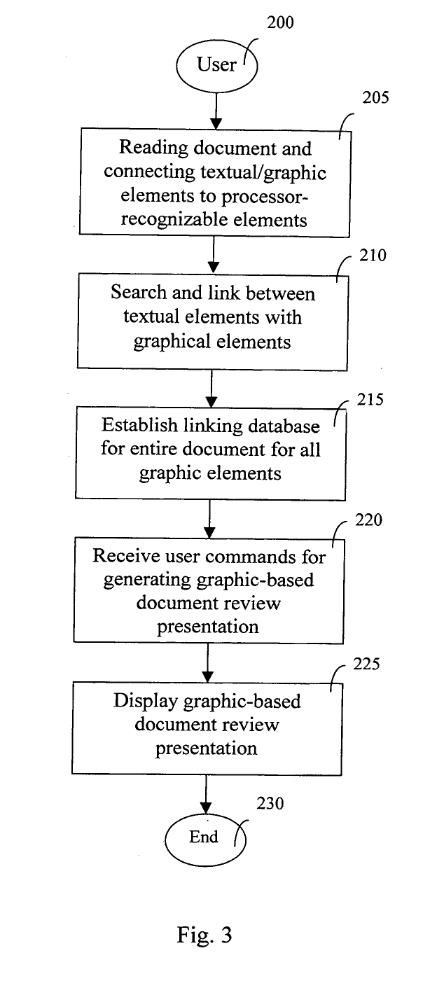

FIG. 3 is a flow chart for illustrating the processing steps carried out by the document management system 100 for providing a graphic-based review version of an input document that includes several sections having textual descriptions and drawings. The document management process begins (step 200) by reading the document and converting the textual and graphic elements of the documents into processor recognizable textual and graphic elements (step 205). The processor-recognizable textual and graphic elements are then processed by the search and link means 120 to search the document by using the alpha-number designations of each of the graphical elements to identify a naming-term in the section of the textual descriptions for each graphic element (steps 210). With a specific naming-term identified for each graphic element, further searches are conducted over the entire document to establish a link database 130 to provide a list. The list links every sentence in the document containing a reference of either the naming-term or the alphanumerical designation of each graphic element (step 215). For each sentence in the document linked to a graphic element, the link database further lists the column number, e.g., column 4, or page number, e.g., page 135, and also the line numbers, e.g., lines 20 to 25, to identify the location of that description related to the graphic element. The document management system 100 further provides to a user a graphic user interface (GUI) for a document reviewer to input commands for providing various kinds of graphic-based document review presentations (step 220). In responding to the user commands, a graphic-based document review presentation is displayed on the display means of the document management system 100 (step 225).

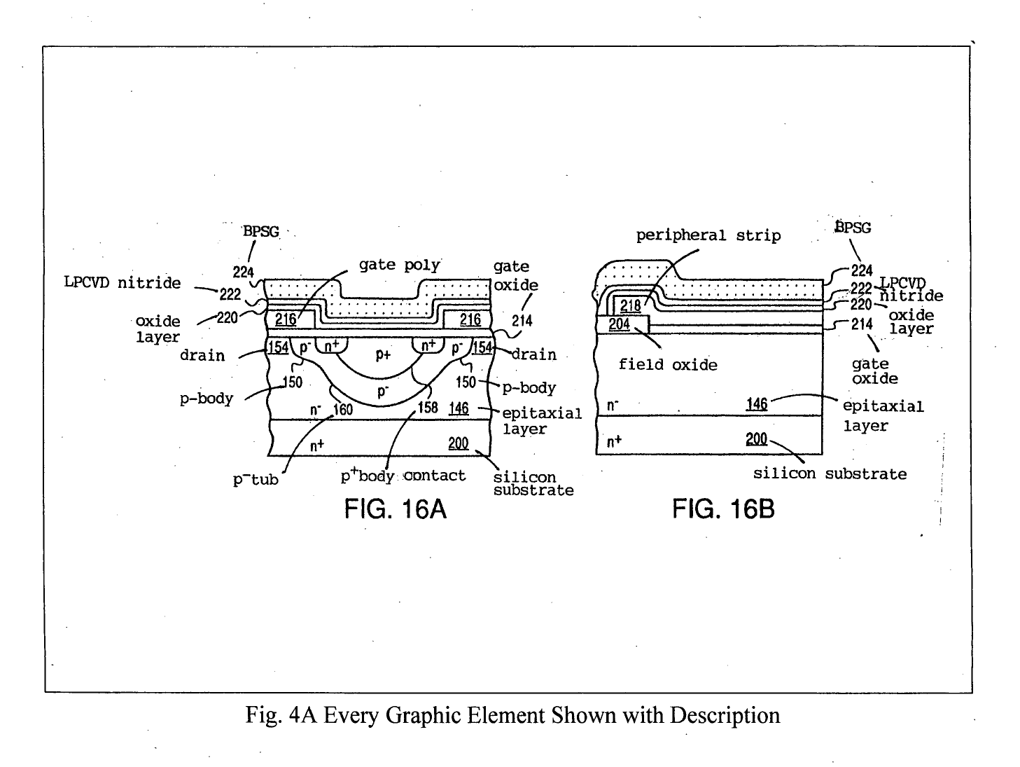

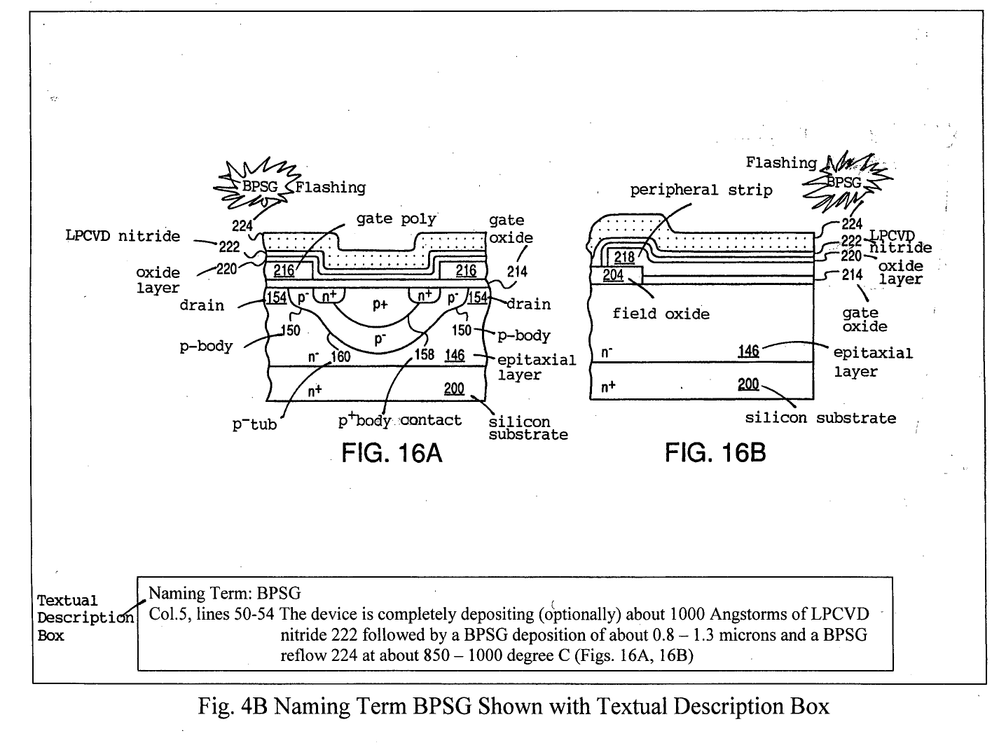

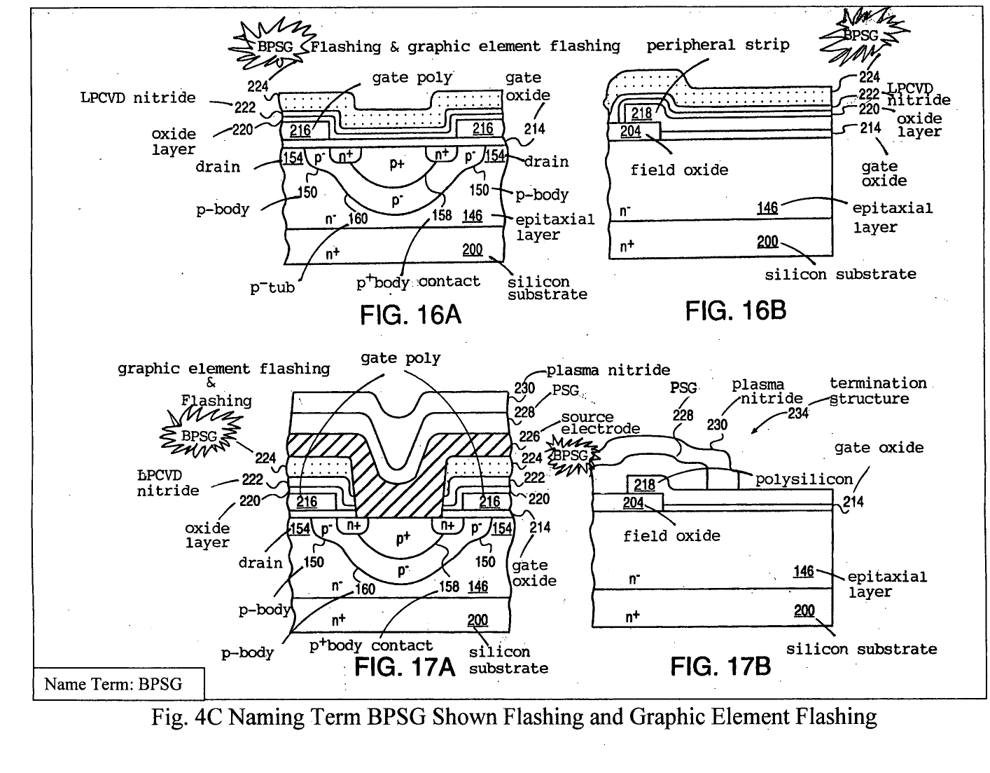

FIG. 4A is an exemplary display of a graphic-based review-document as processed by the document management system of this invention. For each graphic element, a user has several options for selecting a graphic representation of each drawing included in the document. These options are describe below:
1) A user can select to display a drawing with each of the alpha-numeral designations displayed side-by-side with a naming-term as that shown in FIG. 4A.
2) A user can then select one or several graphic elements by double clicking on the alpha-numeral designation or the naming-term to display a textual-description box next to the graphic element. The textual description box will also display the column number, page number and line number for each textual description to provide location of these relevant textural descriptions in the document. An alpha-number designation may include a drawing designation such as “FIG. 4A”. Upon a user's double click on “FIG. 4A” the textual description box will display relevant textual description for “FIG. 4A”. For a patent document, the claim number and line number will also be shown associated with the naming term associated with the alpha-numeral designation (See FIG. 4B).
3) A user is also provided with an option to input a user-selected naming-term as input. In response to the user-selected input naming-term, the document management system will link to one or several drawings of the document associated with the user-selected naming-term. (See FIG. 4C) The document management system will show the first drawing associated with the user-selected naming-term. The document management system will also show all the naming-terms associated with all the alpha-numeral designations of that drawing. The user then has the options to examine more drawings and the detail descriptions for each of the graphic element based on options 1) or 2) above. The display means 150 of the document management system 160 further provides a highlight display for the graphic elements for each of the naming terms. The highlight display may be in special color, special bold profile of the graphic elements or a flashing display for each of the graphic elements when user point a cursor to a particular naming-term in the textual description box shown side by side with the drawing or drawings.

A Patent Examiner is often encountered with the requirements of linking all the claimed elements to a section of supporting descriptions, either textual or graphical, provided in the entire document. The document management system 100 as disclosed here is provided to aid and enhance the examination of a patent document. In addition to the benefits of more conveniently linking the textual descriptions to the graphical elements in the documents, the document management will aid to the quality of document examination. This is because better understanding of the document will be enhanced with presentations between the textual descriptions correlated to the graphic elements showing as graphical presentations. For patent examination, a Patent Examiner can easily find out if any term included in a claim is supported in the Specification or Drawings by entering that term to invoke a graphic display and the column and line numbers for description of that term.

Therefore, the present invention provides a document management system for linking and presenting each of the graphical elements to associated textual descriptions and related claimed elements such that the difficulties and inconveniences are resolved. Specifically, the present invention provides a novel document management and presentation system to search and link textual descriptions and elements in different claims of a patent document associated with each of the alpha-numeral designations of the graphic elements. A link is first established between each of the alpha-numeral designations for each of the graphical elements to a naming-term of a first textual description associated with that alpha-numeral designation. Then all related descriptions for that particular naming-term are linked and gathered in a list file for that graphic element. The list file can then be displayed along with the associated graphic element for convenience of document review. A novel graphic-based document review system is disclosed by providing user options to either review the drawings with textual descriptions or claim languages of a patent document displayed in a text box next to a related graphic element. Or, a document reviewer may enter a naming-term to invoke a graphic presentation related to that naming-term and all the associated descriptions and/or claim languages for that naming-term in a text box next to the graphic element associated with that naming-term.

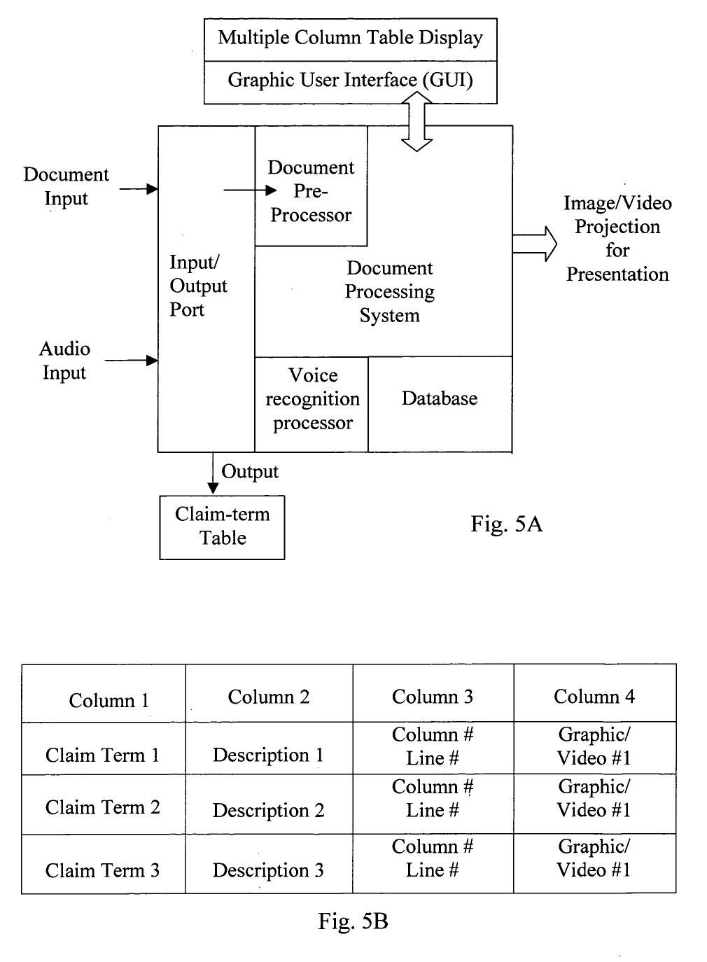

This invention further discloses a patent document processing system as shown in FIG. 5A with a document reader and preprocessor to read and process a patent document. The patent includes at least a claim. The claim further includes a plurality of claim elements and a description section for describing each of the claim elements. The patent document processing system further includes a processor for constructing a claim-term table for searching and finding a portion in the description for describing at least a claim element and constructing a multiple-column table listing the claim element on a first column and the portion of the description in a second column as illustrated in FIG. 5B. In a preferred embodiment, the processor for constructing a claim-term table further determines a column-number and a line number of the portion in the description in the patent for indicating the column-number and the line-number in the second column of the multiple-column table. In another preferred embodiment, the column number and line number are provided as a user interface to the user to link and display a portion of the patent indicated by the column number and line number. In another preferred embodiment, the portion indicated by the column number and the line number is highlighted in the display. In another preferred embodiment, the patent further includes at least a drawing and the processor for constructing a claim-term table further determines a drawing-number showing the claim element for indicating the drawing-number in the second column of the multiple-column table. In another preferred embodiment, the drawing-number is further provided as a user-interface for a user to link and display the drawing. In another preferred embodiment, the processor further constructs a third column for displaying a shrunken image of the drawing as a user-interface for a user to link and display the drawing. In another preferred embodiment, the drawing-number is further provided as a user-interface for a user to link and display the drawing with a graphic element in the drawing related to the claim term particularly highlighted. In another preferred embodiment, the processor further constructs a third column for displaying a shrunken image of the drawing as a user-interface for a user to link and display the drawing with a graphic element in the drawing related to the claim term particularly highlighted. In another preferred embodiment, the processor further constructs a graphic/video column for displaying a shrunken image of a claim-term relevant drawing as a user-interface for a user to link and display a graphic or video image for making a presentation relating to the claim term. In another preferred embodiment, the processor further constructs a graphic/video column as that shown in FIG. 5B as column 4, for displaying a shrunken image of a claim-term relevant drawing as a user-interface for a user to link and display a graphic or video image for making a presentation relating to an infringing product against the claim term. In another preferred embodiment, the system further includes a display device for displaying the claim term table and a plurality of graphic or video images relevant to the claim term. In another preferred embodiment, the system further includes a voice recognition processor as that shown in FIG. 5A, for receiving and recognizing an audio input for linking to a claim term based on a content of the audio input. In another preferred embodiment, the system further includes a voice recognition processor for receiving and recognizing an audio input for linking to a claim term based on a content of the audio input. The system further includes a display device for displaying the claim term table and a plurality of graphic or video images relevant to the claim term recognized and linked by the voice recognition processor. In another preferred embodiment, the system a voice recognition processor for receiving and recognizing an audio input including a voice command and a display device for displaying a plurality of graphic or video images according to the voice command.

This invention also discloses a document processing system for receiving a user input to process a document. The document processing system includes a processor for constructing a multiple-column table for searching and finding a first relevant portion in a first section of a document to a second relevant portion in a second section of the document and placing the first and second relevant portions side-by-side in the multiple-column table. In a preferred embodiment, the system further includes a voice recognition processor as that shown in FIG. 5A, for receiving and recognizing an audio input for constructing the multiple-column table. In another preferred embodiment, the system further includes a voice recognition processor for receiving and recognizing an audio input. The system further includes a display device for displaying a plurality of graphic and video images according to the audio input recognized by the voice recognition processor. In another preferred embodiment, the document processor further counts a page number and line number respectively for the first and second relevant portions for indicating the page number and line number in the multiple column table. In another preferred embodiment, the document processor further processing at least a drawing in the document for placing a drawing number relevant to the first and second relevant portions in the multiple-column table. In another preferred embodiment, the document processor further places a reduced-sized image of the drawing relevant to the first and second relevant portions in a separate column in the multiple-column table. In another preferred embodiment, the system further includes a data base for storing additional graphic or video images related to the first and second relevant portions. The document processor further processes the graphic or video images for placing a reduced-sized image of the one of the graphic or video images relevant to the first and second relevant portions in a separate column in the multiple-column table.

This invention further discloses a document processing system that includes a voice recognition processor for receiving and recognizing an audio input. The system further includes a display device for displaying a plurality of graphic or textual images of a document according to the audio input recognized by the voice recognition processor. Specifically, the voice recognition processor further receives and recognizes an audio input indicating a specific portion of a document. Then, the display system further displays the specific portion, e.g., a recognized page number, of the document as that recognized by the voice recognition processor.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A patent document processing system for processing a patent having at least a claim including a plurality of claim elements and a description section for describing each of said claim elements, said patent document processing system comprising:
a processor for constructing a claim-term table for searching and finding a portion in said description for describing at least a claim element and constructing a multiple-column table listing said claim element on a first column and said portion of said description in a second column.

2. The patent document processing system of claim 1 wherein:
said processor for constructing a claim-term table further determining a column-number and a line number of said portion in said description in said patent for indicating said column-number and said line-number in said second column of said multiple-column table.

3. The patent document processing system of claim 1 wherein:
said patent further includes at least a drawing and said processor for constructing a claim-term table further determining a drawing-number showing said claim element for indicating said drawing-number in said second column of said multiple-column table.

4. The patent document processing system of claim 1 wherein:
said patent further includes at least a drawing and said processor for constructing a claim-term table further determining a drawing-number showing said claim element for displaying a drawing-number in said second column of said multiple-column table wherein said drawing-number is further provided as a user-interface link for a user to link and display said drawing.

5. The patent document processing system of claim 1 wherein:
said patent further includes at least a drawing and said processor for constructing a claim-term table further determining a drawing-number showing said claim element and;
said processor further constructing a third column for displaying a shrunken image of said drawing as a user-interface for a user to link and display said drawing.

6. The patent document processing system of claim 1 wherein:
said patent further includes at least a drawing and said processor for constructing a claim-term table further determining a drawing-number showing said claim element for displaying a drawing-number in said second column of said multiple-column table wherein said drawing-number is further provided as a user-interface link for a user to link and display said drawing with a graphic element in said drawing related to said claim term particularly highlighted.

7. The patent document processing system of claim 1 wherein:
said patent further includes at least a drawing and said processor for constructing a claim-term table further determining a drawing-number showing said claim element and;
said processor further constructing a third column for displaying a shrunken image of said drawing as a user-interface for a user to link and display said drawing with a graphic element in said drawing related to said claim term particularly highlighted.

8. The patent document processing system of claim 1 wherein:
said processor further constructing a graphic/video column for displaying a shrunken image of a claim-term relevant drawing as a user-interface for a user to link and display a graphic or video image for making a presentation relating to said claim term.

9. The patent document processing system of claim 1 wherein:
said processor further constructing a graphic/video column for displaying a shrunken image of a claim-term relevant drawing as a user-interface for a user to link and display a graphic or video image for making a presentation relating to an infringing product against said claim term.

10. The patent document processing system of claim 1 wherein:
said processor for constructing a claim-term table further determining a column-number and a line number of said portion in said description in said patent for indicating said column-number and said line-number in said second column of said multiple-column table wherein said column-number and said line-number are further provided as a user-interface for a user to link and display an image for a portion of said patent highlighting said portion of said description.

11. The patent document processing system of claim 1 wherein:
said processor further constructing a graphic/video column for displaying a shrunken image of a claim-term relevant drawing as a user-interface for a user to link and display a graphic or video image for making a presentation relating to a functional analysis relevant to said claim-term as listed on said first column.

12. The patent document processing system of claim 1 further comprising:
a display means for displaying said claim term table and a plurality of graphic or video images relevant to said claim term.

13. The patent document processing system of claim 1 further comprising:
a voice recognition processor for receiving and recognizing an audio input for linking to a claim term based on a content of said audio input.

14. The patent document processing system of claim 1 further comprising:
a voice recognition processor for receiving and recognizing an audio input for linking to a claim term based on a content of said audio input; and
a display means for displaying said claim term table and a plurality of graphic or video images relevant to said claim term recognized and linked by said voice recognition processor.

15. The patent document processing system of claim 1 further comprising:
a voice recognition processor for receiving and recognizing an audio input including a voice command; and
a display device for displaying a plurality of graphic or video images according to said voice command.

16. A document processing system for receiving a user input to process a document comprising:
a processor for constructing a multiple-column table for searching and finding a first relevant portion in a first section of a document to a second relevant portion in a second section of said document and placing said first and second relevant portions side-by-side in said multiple-column table.

17. The document processing system of claim 16 further comprising:
a voice recognition processor for receiving and recognizing an audio input for constructing said multiple-column table.

18. The document processing system of claim 16 further comprising:
a voice recognition processor for receiving and recognizing an audio input; and
a display device for displaying a plurality of graphic and video images according to said audio input recognized by said voice recognition processor.

19. The document processing system of claim 16 wherein:
said document processor further counting a page number and line number respectively for said first and second relevant portions for indicating said page number and line number in said multiple column table.

20. The document processing system of claim 16 wherein:
said document processor further processing at least a drawing in said document for placing a drawing number relevant to said first and second relevant portions in said multiple-column table.

21. The document processing system of claim 16 wherein:
said document processor further processing at least a drawing in said document for placing a reduced-sized image of said drawing relevant to said first and second relevant portions in a separate column in said multiple-column table.

22. The document processing system of claim 16 further comprising:
a data base for storing additional graphic or video images related to said first and second relevant portions; and
said document processor further processing said graphic or video images for placing a reduced-sized image of said one of said graphic or video images relevant to said first and second relevant portions in a separate column in said. multiple-column table.

23. A document processing system comprising:
a voice recognition processor for receiving and recognizing an audio input; and
a display device for displaying a plurality of graphic or textual images of a document according to said audio input recognized by said voice recognition processor.

24. The document processing system of claim 23 wherein:
said voice recognition processor further receiving and recognizing an audio input indicating a specific portion of a document; and
said display device further displays said specific portion of said document recognized by said voice recognition processor.
